(19) United States
(12) Patent Application Publication
(10) Pub. No.: US 2002/0152125 A1
(43) Pub. Date: Oct. 17, 2002

(54) Internet-based e-commerce settlement system

(76) Inventor: Geoffrey S. Goedde, Louisville, CO (US)

Correspondence Address: TransPotomac Plaza, 1033 N. Faifax St., Suite 306, Alexandria, VA, 22314, US

(21) Appl. No.: 09/832,125

(22) Filed: Apr. 11, 2001

(51) Int. Cl. G06G 1/14

(52) U.S. Cl. 705/22; 705/28

(57) ABSTRACT

A network-based system for simultaneous remuneration of a multiplicity of parties to a transaction is disclosed. A new method and system of trusted settlement of accounts for a multiplicity of parties using credit transactions, debit transactions, electronic checks and other forms of trade currency. The system enables the proceeds from a transaction to be automatically distributed to a multiplicity of parties with an interest in the transaction, based on prior agreements and contractual arrangements, thereby eliminating the internal overhead cost for both the Accounts Receivable and Accounts Payable processes for all parties concerned.

### FIELD OF THE INVENTION

This invention relates to electronic commerce. Specifically, this invention relates to an inventory and revenue settlement system for selling goods or services via a network.

### BACKGROUND OF THE INVENTION

As commerce is increasingly conducted using electronic networks, a multiplicity of parties with a direct financial interest can and will be directly included in any individual transaction. The ultimate goal of conducting commerce across an electronic network is to enable all parties to participate in a transaction in as close to real time as possible.

Traditional channels of distribution have heretofore not been interconnected, and therefore conducting operations in, or near real time was impossible for many and impractical for all but the largest, most well funded companies. In the traditional modes of commerce, distribution of goods is conducted serially, from manufacturer to wholesaler or distributor to reseller and then to consumer. However, over time, newer business models have emerged that attempt to remove the middleman in a transaction.

The advent of a means of achieving inexpensive network connections, such as through the Internet or Web, has the potential of allowing any participant in a distribution channel to communicate more easily with any other participant in the channel, thus facilitating circumvention of intermediaries. This increasing ubiquity of interconnection also provides new means to accelerate business and reduce its cost between long-standing trading partners, thereby enhancing the capability for all parties to form new trading partnerships. Any member of the supply chain can now sell “virtual inventory” online and eliminate the intermediary.

The serial nature of the way traditional commerce is conducted is insufficient to deal with the demands imposed by network commerce, creating structural barriers by introducing processing delays and high costs to all the parties to the transaction.

To enable all parties to a transaction to participate in as near to real time as possible, network commerce requires new systems that remove the serial processing for buying and selling of goods and service in a channel, by instituting simultaneous processing for the settlement of all account for all parties to a transaction.

Conventional accounting systems are not prepared to deal effectively with products being sold to a second party (not yet owned by the first party), for delivery by a third party. Conventional accounting systems require linear accounting procedures for a multiplicity of transactions between the parties. For example, using the traditional model, Party A sells some good or service, which is purchased by party B, to be delivered by Party C, from the inventory of Party D. These transactions trigger an internal accounts-receivable process for Party A; A sends an invoice to Party B. The receipt of the invoice from Party A by Party B, which in turn triggers a corresponding internal accounting process, initiating an accounts-payable process to pay the amount of the invoice to Party A. Another set of similar accounts-receivable (AR)/accounts-payable (AP) processes is then engendered by the transaction, between Party A and Party D. In addition, depending on which of the Parties assumes responsibility for the delivery of the goods by Party C, then another set of accounts-receivable and accounts-payable processes is required between the responsible Party and Party C for the payment for the delivery service.

Usually, when a multiplicity of parties are involved in a single transaction, each of the parties is likely to be in a completely different line of business, delivering a separate good, unlike that delivered by any of the other parties to the transaction, and may use a different method of accounting for the transaction. Because these AR and AP processes are the internal operations of each party, designed to uniquely serve each party, the processes of any one party are generally incompatible with the processes used for essentially the same purpose that are employed by the multiplicity of the other possible parties to the transaction.

The incompatibility of the internal accounting processes among a multiplicity of parties is a result of many valid business reasons and legitimate variances between the parties, in the ways in which they individually choose to track and account for the purchases and sales of the goods and services. The internal processing operations for AR and AP are costly to and time-consuming for each party to the transaction. While each party to the transaction may work to automatic the throughput and efficiency, and reduce the overhead cost of their internal processing operations, some will be more effective than others will in this regard.

The aggregate differences in processing effectiveness between each party to a transaction, causes increased expense and delay for all parties to the transaction. The increase in expense and added delay are amplified in network commerce.

The greater the number of parties to a single transaction, the greater the jointly induced overhead and delay engendered by the transaction. Network commerce enables the collaboration of an increasing multiplicity of parties, all adding their individual values to the transaction, in near to real time. The previously described joint overhead expense for a single transaction is a major inhibitor to conducting business on a single transaction basis. The overhead expense, on a single transaction basis, directly limits the ability of all parties to conduct business on a cost/benefit basis.

The direct limitation to this type of financial arrangement is the inherent combined-overhead expense of processing the transaction. If the inherent cost of processing the transaction is close to, equal to, or in excess of the value exchanged by the transaction, then the transaction becomes impractical. As does the basic business proposition and perhaps the business relationship, as well.

Most of the internal accounting systems in-place today are poorly equipped to accommodate the multiplicity of new and different contractual relationships possible in the network economy. While each enterprise will evolve and modify their internal accounting processes to accommodate each new type of relationship, the task will be expensive, complicated, and time-consuming for each individual enterprise. As a result, conventional contractual relationships are expensive to maintain.

Conventional industry practice is to establish a merchant account in the name one party to the transaction, depositing the proceeds from transactions into that account for any transactions conducted by that party. This practice internalizes the accounting process and essentially dictates that the party with the merchant account becomes more or less responsible for the payment of other parties to the transaction. From this merchant account all parties to the transaction are paid. This practice engenders delay in the payment/remuneration of the other parties and adds overhead expense for the party with the merchant account, because the transaction is thereby made an internal AP process (or multiple processes) for the responsible party.

The industry average cost per single AP process is estimated to be in excess of $75 and the average cost per single AR process is estimated to be in excess of $25. As the number of parties to a transaction increases, the joint-overhead processing cost increases. For example, for a simply transaction on the Internet, there can be 9 parties involved. Using the industry average overhead cost, the above transaction joint-overhead cost would be in excess of $800 (8×$75+8×$25). This level of per-transaction overhead expense quickly will become intolerable for use in network commerce.

Even if all the parties succeed in reducing their individual AR/AP processing costs by 95%, then the joint-overhead expense would still exceed $40 for the above example. For the foreseeable future, most of the parties involved will be unable to reduce their internal processing cost by 95%, because they continue to process accounts-payable and accounts-receivable for non-network commerce transactions.

The effectiveness of any individual party employing new electronic techniques for bill-presentment (invoicing, billing, et al) and payment acceptance (electronic funds transfer, ACH, etc) in order to reduce internal processing expense in the new network commerce environment, is severely limited by the ability of any and all the other parties to a transaction to employ compatible techniques.

A vast preponderance of the business conducted via network commerce does, and will continue to employ payment mechanisms based on old credit-debit instruments, checks and other forms of tradable currency.

Authorization of these payment mechanisms (such as credit card purchases) is most often performed by third party service providers (and teams of service providers working in concert) like banks and card authorization processors. They are inherently parties to the transaction, as facilitators of network commerce.

Incompatible systems between trading-partners (in both network and non-network commerce) cause the cost per transaction to increase for each party to the transaction. Making the internal systems of each party compatible (interoperable) with each of the internal systems of all the other parties is a daunting challenge. Many billions of dollars have been and are being spent to build and overhaul internal systems to accommodate the demands of network commerce.

A new business framework is enabled by network commerce that takes advantage of distributed virtual inventories; i.e., inventories located other than on-site, which make it no longer necessary for a product sold in any one location to be shipped from that location. In the virtual inventory model, a product can purchased in any location and be delivered directly to the buyer, from any other location where that product is available, “as if sold” by the party at the original location.

Each of the parties (or a multiplicity of parties) will still be able to employ their unique internal accounting process (i.e., a process driven by rules and/or procedures specific to that party) to track and account for what is bought and/or sold between that party and one or more of the other parties to a transaction.

It is the uniqueness of the individual transaction processing capabilities of each of the parties that creates and reinforces trading-process distinctions between them. These differences in transaction processing capability (like speed, cost and/or methods) introduce incompatibilities and interruptions into the distribution channel in which these parties all intend to conduct business.

The present invention addresses these and other problems inherent in network commerce.

### SUMMARY OF THE INVENTION

It is therefore a goal of the present invention to “externalize” the AP and AR processes for each and every one of the parties to a transaction by performing these activities simultaneously on the network. It is further a goal of the invention to eliminate the need for each party to internalize these processes, by enabling the settlement of accounts simultaneously between all parties to the transaction in an automated fashion, operating outside the internal accounting procedures of any of the parties.

An advantage of the present invention in this context lies in its ability to inexpensively and simultaneously solve a common problem for a multiplicity of parties to any transaction, by providing a rules-based, shared-solution, which is deployable far faster and at far less cost, than any single enterprise can develop on an individual basis.

The present invention provides a software system and method for enabling all parties to an Internet sales transaction to reduce their transaction costs. The system and method are implemented in part by software that can be licensed and that will run on the merchant's website or system operator's server.

In another preferred embodiment, the merchant site can also maintain a “tax account” which will contain the calculated sales tax due from the transaction. The appropriate “collected taxes” would then be periodically distributed to the appropriate (local, county, and state) taxing authority.

An important benefit of this feature is that it eliminates a majority of the reseller's traditional costs of periodically calculating the tax amounts due to a multiplicity of tax collection agencies, and as such, eliminates the overhead cost in preparing, printing and issuing small dollar amounts (micropayments) to all those taxing agencies that become involved in network commerce. This method empowers all parties to the transaction to audit their tax status in an easy, straightforward and very much lower-cost fashion, than is currently available. Another benefit of this feature is that this method allows for the aggregation of a multiplicity of tax payments and therefore the remittance of numerically fewer payments to each tax collecting authority, thus saving on the overall processing overhead cost, for each of those authorities.

### BRIEF DESCRIPTION OF THE DRAWINGS

FIG. 1 is a flow diagram illustrating the path the funds travel in the system.

FIG. 2 is a flow diagram illustrating the external accounts-payable/accounts-receivable system.

FIG. 3 is a diagram illustrating a preferred embodiment of the invention.

FIG. 4 is a diagram illustrating an alternate embodiment of the invention.

FIG. 5 is a diagram illustrating an alternative embodiment of the invention where the system operator is telecommunications provider (wireline or wireless).

FIG. 6 is a diagram illustrating an alternative embodiment of the invention where an Internet Service Provider is the system operator.

FIG. 7 is a diagram illustrating an alternative embodiment of the invention where a credit card issuer/acquirer is the system operator.

FIG. 8 is a diagram illustrating an alternative embodiment of the invention where a trading hub is the system operator.

FIG. 9 is a diagram illustrating an alternative embodiment of the invention where one of the transaction parties is the system operator.

FIG. 10 is a diagram illustrating an alternative embodiment of the invention where a state and local government is the system operator.

FIG. 11 is a diagram illustrating an alternative embodiment of the invention where a firm specializing in billing is the system operator.

FIG. 12 is a diagram illustrating an alternative embodiment of the invention where a shipping agent is the system operator.

FIG. 13 is a diagram illustrating an alternative embodiment of the invention where a power company is the system operator.

FIG. 14 is a diagram illustrating an alternative embodiment of the invention where a cable television service provider is the system operator.

### DETAILED DESCRIPTION AND PREFERRED EMBODIMENTS

The invention will now be described in more detail by way of example with reference to the embodiments shown in the accompanied figures. It should be kept in mind that the following described embodiment(s) is only presented by way of example and should not be construed as limiting the inventive concept to any particular physical configuration.

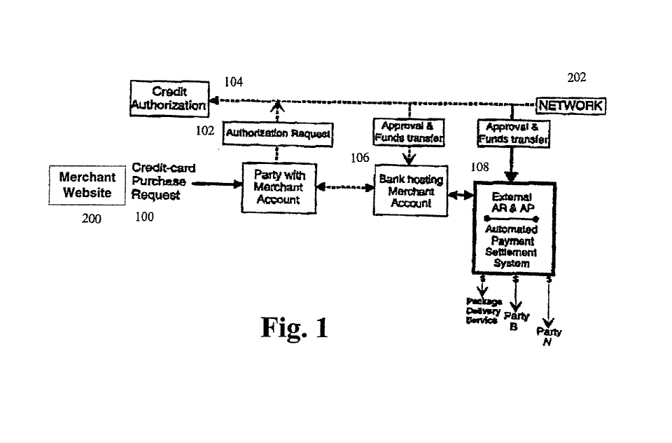

FIG. 1 illustrates the flow of transaction proceeds in accordance with the present invention. The system includes a customer's purchase which stimulates a credit card purchase request 100, a merchant website 200, a credit card authorization request 102, a network 202, credit authorization 104, funds transferred into merchant account 106 and the remainder of funds transferred into external account setup by the automated payment system 108.

The process commences when a customer accesses a merchant website 200 using a standard Web browser, such as Netscape Explorer or MS Internet Explorer, which uses the Hypertext Transport Protocol to communicate to the merchant website 200.

In a preferred embodiment, the customer browses the merchant website 200 and purchase various items with a credit card. In an alternate embodiment of the invention, a customer can purchase with a check or cyber cash as well. The customer enters his or her credit card information into the merchant website 200, which triggers a purchase request 100 by the customer. The merchant website 200 automatically forwards the purchase request 100 to the appropriate credit card processor for credit authorization 102.

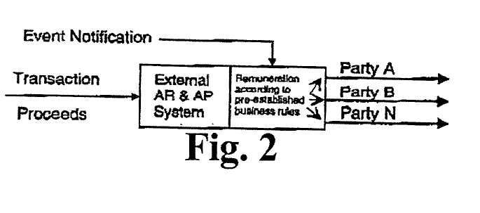

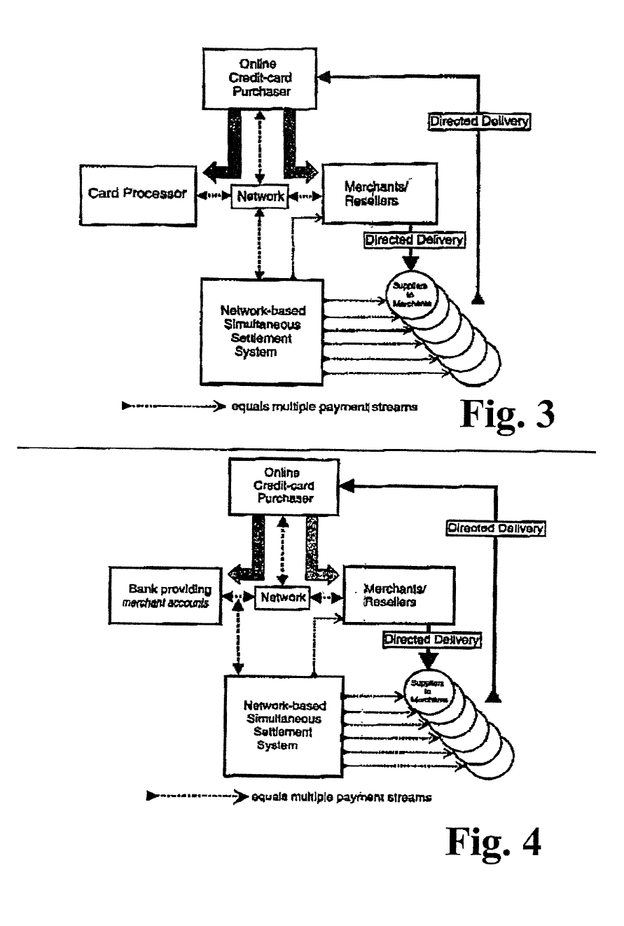

In a preferred embodiment of the invention (FIG. 3), the credit card agency upon credit approval 104 transfers the transaction proceeds into a merchant account 106 via the network 202. Simultaneously, the credit card agency will transmit the remainder of the funds into a series of “accounts” setup by the automated payment system operator for the other multiplicity of parties in the transaction. FIG. 2 illustrates the external AP/AR automated system that allows any party to a transaction to be remunerated immediately according to a contractual relationship between the parties (1-N) involved in the transaction.

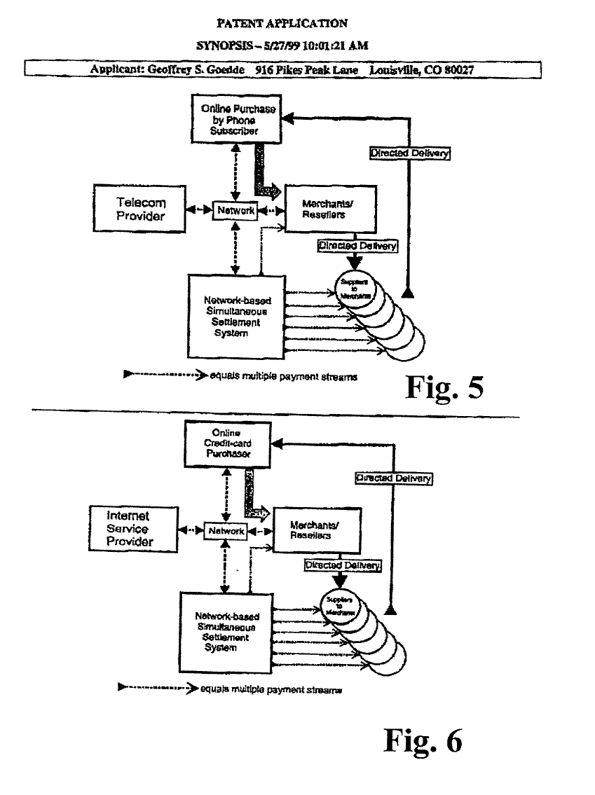

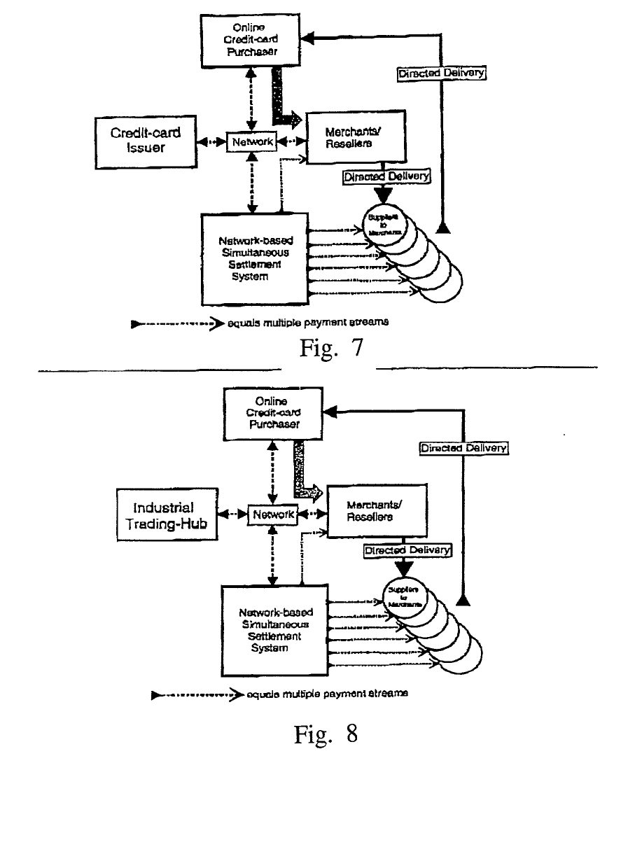

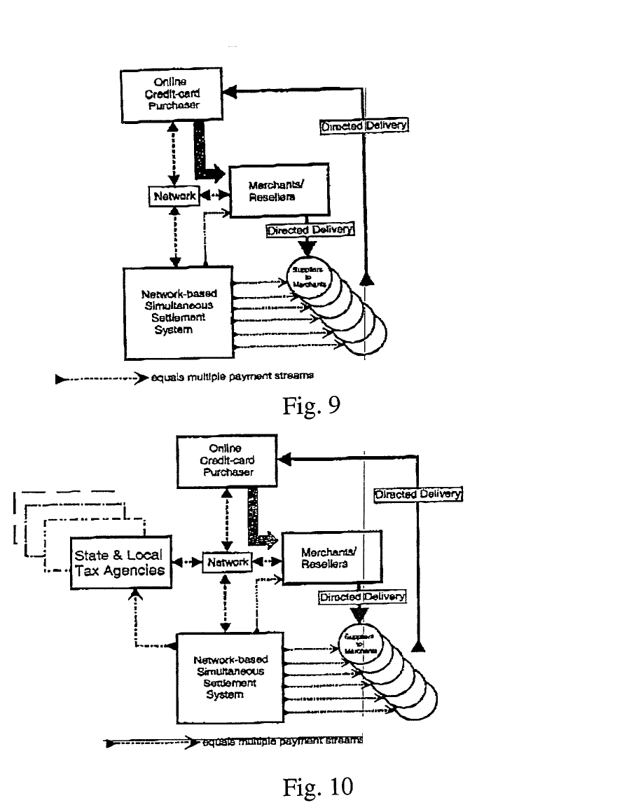

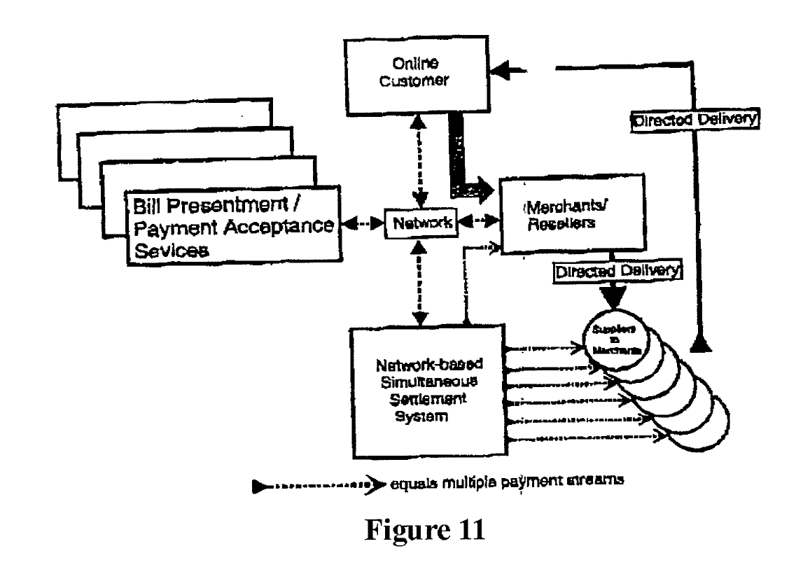

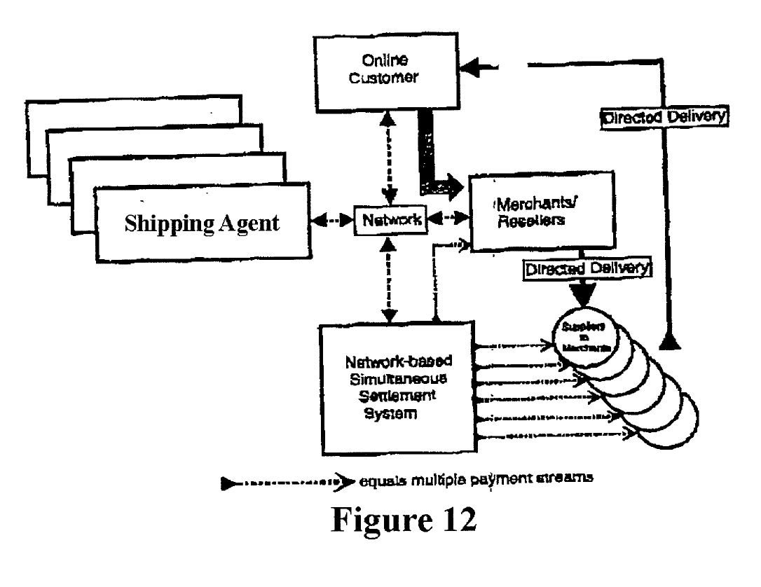

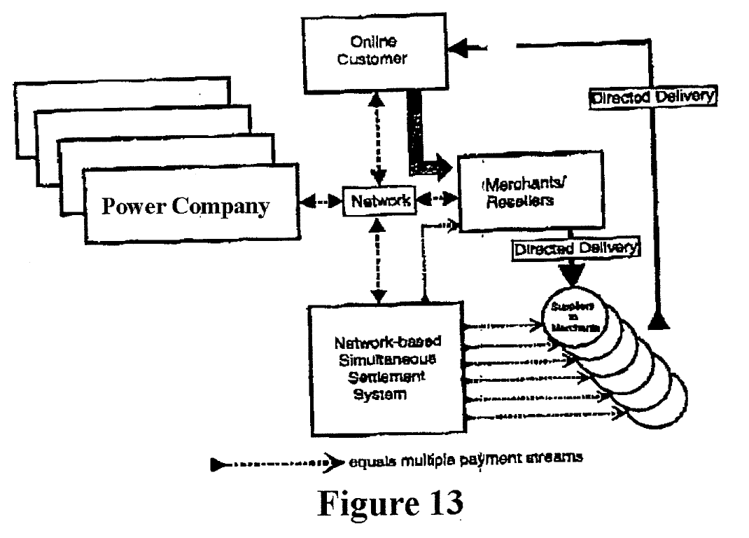

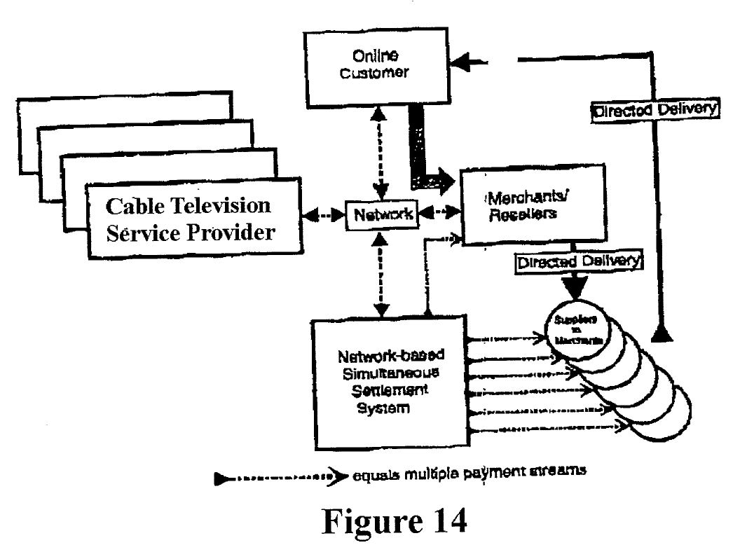

The system operator, in the preferred embodiment is the credit card processor who sets up electronic “virtual accounts” to transfer the transaction proceeds into. In an alternate embodiment of the invention, the system operator can be the bank providing the merchant account (FIG. 4), FIGS. 5 through 11 illustrates other possible system operators as alternative embodiments of the invention. However, there are numerous possibilities for system operators and these examples are not exclusive. As mentioned above, the system operator will transfer the transaction proceeds to the respective parties according to contractual relationships and business rules. The electronic funds transfer will be done using an ACH system. The ACH system is a nationwide electronic funds transfer system that provides for the interbank clearing of credit and debit transactions and for the exchange of information among participating financial institutions.

The system embodies a multiplicity of calculation capabilities to accommodate the needs of all the parties to a transaction. The calculation capability can determine the appropriate distribution of proceeds, based on but not limited to any mathematical formula applied and based on any periodic date, time and/or interval, and based on any external events desired by the parties. A secure database will be used to store the contractual relationships of all parties to a transaction. This secure database can be of any type of data repository, for example, using such formats as SQL or ASCII. A web browser function will be made available to each of the potential parties to a transaction that enables the parties to establish and agree upon the terms and conditions for transacting business. Once the terms and conditions for transactions are agreed upon, each party will electronically certify their agreement, which will become the basis of the rules determining the distribution of proceeds; i.e., the percentage due each party, percent of holdback (if any), etc. Each party to the agreement will enter their bank account number and bank routing instructions.

The contractual agreement also governs which parties may adjust or modify the on-going distribution of proceeds, and whether any of the parties may make such adjustments of modifications unilaterally, or whether the other parties must agree to and authorize any changes.

The system uses rules-based procedures, stored internally, to calculate the appropriate splits, delays, holdbacks, etc. according to terms and conditions stored in a database. This way, each owner of a “virtual account” will have real time or close to real time access to the transaction funds as soon the credit is approved.

An interactive programming language controls the present invention. In the preferred embodiment of the invention, the interactive programming language is a combination of Java® and C++. The interactive programming language permits one or more parties (depending on their mutual agreement/contractual arrangement) to modify the settlement of proceeds that governs transactions between them. For example: in a transaction between a merchant and a supplier of goods, the merchant can reduce the amount of proceeds due him, thereby increasing the amount going to the supplier, without explicit permission of the other parties. But, the merchant cannot increase the amount due him, without explicit permission from the supplier. Likewise, the supplier can decrease the amount due him without permission of the merchant (essentially lowering his price), but not increase the amount due him without explicit permission of the merchant.

The parties to the transaction may include the manufacturer, distributor, Internet service provider, collection agent, wholesaler, shipping agent, taxing authorities, contractor, telephony provider, cable television service provider, etc.

In an alternate preferred embodiment (FIG. 2), one of the potential parties (N) to the transaction could be a sales taxing authority. The proposed system would incorporate the sales tax table(s) appropriate to the location of the buyer and/or the seller (depending on how the tax collection is determined), and then calculate the taxes due from the transaction and electronically remit the appropriate funds to a “tax account” established for the responsible party.

The appropriate “collected taxes” would then be periodically electronically distributed to the appropriate (local, county, and state) taxing authorities/agencies. The “tax account” of the responsible party will allow credit and debit of funds, as “holdbacks” appropriate to accounting for returns, charge backs, and sales-reversal, et al. The “tax accounts” may be interest bearing.

A further advantage is that a shipping agent delivering a product engendered by the purchase transaction between a supplier and a customer can be remunerated immediately upon receipt of a proof-of-delivery signal from that agent. In the same way, a provider of advertising services and a provider of demographics content analysis can be remunerated at the time of sale, as well as a provider of network services can be remunerated on a single transaction basis.

On a periodic basis, the system operator will generate a statement or a transaction report and forward this report to all parties involved in the transaction.

It will be apparent to one skilled in the art that the manner of using the claimed invention has been adequately disclosed in the above-written description of the embodiment(s). It will be understood that the above-described embodiment(s) of the present invention are susceptible to various modifications, changes, and adaptations, and the same are intended to be comprehended within the meaning and range of equivalents of the appended claims.

A person skilled in the art will understand that there may be other equivalent components presently known, or to be developed, which could be used within the spirit and scope of the invention defined by the claims.

What is claimed is:

1) An external method of revenue allocation for sales of products and services from a virtual inventory comprising:
a. Providing a software settlement system that allows retail parties the ability to reduce their transaction cost once a customer electronically purchase an item from an inventory;
b. purchasing a item from a website;
c. requesting credit approval and upon approval funds are transferred into a merchant account, or series of merchant accounts;
d. processing and automatically calculating simultaneously the exact remuneration due to each party to the transaction;
e. creating an account to remit the appropriate funds; and
f. directing the transfer of the appropriate funds to each party of the transaction at the appropriate time.

2) The method according to claim 1, whereby the software settlement system can be network-based.

3) The method according to claim 1, whereby the settlement system can be used by ecommerce trading partners.

4) The method according to claim 1, whereby the purchase of an item can be made with a credit card, cyber cash, check, or other fiduciary instrument.

5) The method according to claim 1, whereby the automatic calculation based on a set of pre-established business rules or agreements, where these relationships are stored in a database on at least one server.

6) The method according to claim 5, whereby said database may be of any type of data repository including SQL or ASCII.

7) The method according to claim 1, whereby the transfer of funds to the appropriate party is performed electronically.

8) The method according to claim 1, whereby the requesting of the credit authorization comprises communicating with a server based on a link defined by said web site to obtain the credit approval for the transaction.

9) The method according to claim 7, whereby an appropriate party can be the online merchant.

10) The method according to claim 7, whereby an appropriate party can be the product manufacturer or service provider.

11) The method according to claim 7, whereby an appropriate party can be the shipping agent.

12) The method according to claim 7, whereby an appropriate party can be the federal, state or local taxing authority.

13) A web-based external accounts settlement system comprising:
Means for creating electronic virtual accounts for a multiplicity of parties to an online transaction
Means for transferring the proceeds of an electronic commerce transaction via the network into the appropriate virtual bank account
Means for providing periodic account and transaction statements to the multiplicity of parties to an online transaction
Means for calculating the amount of the transaction proceeds of an electronic commerce transaction that each of the multiplicity of parties to that transaction is entitled to.

14) The apparatus of claim 13, wherein said transfer of the transaction proceeds comprises using an ACH system.

15) The apparatus of claim 13, wherein the network system is controlled by an interactive programming language (software), installed on the system operator's server and accessible by a remote site(s).

16) The apparatus of claim 13, wherein said interactive programming language comprises the Java® and C++ programming languages.

17) The apparatus of claim 13, wherein said calculation is based on a series of contractual and business agreements, with these relationships stored in a database in at least one server.

18) The apparatus of claim 17, wherein said database may be of any type of data repository including SQL or ASCII.

19) A computer program product for use with a computer, said computer program product comprising a computer usable medium having computer readable program code embodied therein providing means for transferring proceeds from an electronic commerce transaction simultaneously to all of the multiplicity of parties involved in the transaction, decreasing the joint-overhead in the transaction cost, further providing a means for creating “virtual accounts” on the network for the transaction proceeds to be transferred to, on a real time or a quasi real time basis, and means for calculating the percentage of the transaction proceeds entitled to each of the multiplicity of parties to the transaction.
